(19) United States
(12) Patent Application Publication
(10) Pub. No.: US 2009/0189925 A1
(43) Pub. Date: Jul. 30, 2009

(54) LIQUID CRYSTAL DISPLAY AND DRIVING METHOD THEREOF

(75) Inventors: Chun-Wei Huang, Hsinchu (TW); Chien-Hua Chen, Hsinchu (TW); Hsueh-Ying Huang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 12/122,724

(22) Filed: May 19, 2008

(30) Foreign Application Priority Data
Jan. 30, 2008 (TW) 97103466

(51) Int. Cl. G09G 5/10

(52) U.S. Cl. 345/691

(57) ABSTRACT

A liquid crystal display (LCD) and a driving method thereof are provided. The driving method includes the steps of: transmitting video data to the LCD according to a first frequency, and processing the video data according to a first gamma look-up table to obtain a bright region image; transmitting the video data to the LCD according to the first frequency, and processing the video data according to a second gamma look-up table to obtain a dark region image; and stacking the bright region image and the dark region image in sequence so as to display an image displayed on an LCD panel of the LCD.

### CROSS-REFERENCE TO RELATED APPLICATION

This application claims the priority benefit of Taiwan application serial no. 97103466, filed on Jan. 30, 2008. The entirety of the above-mentioned patent application is hereby incorporated by reference herein and made a part of specification.

### BACKGROUND OF THE INVENTION

1. Field of the Invention

The present invention generally relates to a liquid crystal display (LCD) and a driving method thereof, and more particularly, to an LCD and a driving method thereof which are adapted for reducing the problem of wide view angle color shift.

2. Description of Related Art

LCDs having advantages of higher pixel quality, better space utilization, lower power consumption, and non-radiation, have become a main stream of the display market, and are being developed toward higher contrast ratio, faster response, and wider viewing angle. Currently, there are several technologies, including multi-domain vertically alignment (MVA), multi-domain horizontal alignment (MHA), twisted nematic plus wide viewing film (TN+film) and in-plane switching (IPS), are adapted for achieving a wide view angle.

Although an LCD can obtain a wider view angle by implementing any one of the above mentioned technologies, the gamma curve corresponding to a wide view angle is different from that corresponding to a normal view angle. As such, when images displayed by the LCD are viewed by a viewer from a relative deflected angel, e.g., 60°, the viewer senses colors of the image different from that being sensed when viewing from the forward side of the images. This is so-called color shift. In order to improve the problem of color shift when viewing with a wide view angle, it has been proposed to mix a higher gray level color with a lower gray level color to obtain an intermediate gray level color. Two conventional methods for improving the problem of color shift are derived from the proposal.

The first conventional method includes spatially dividing each of the pixels within the LCD panel into two sub-pixels, and applying two different driving voltages respectively to the two sub-pixels according to a target gray level of each pixel, in which an equivalent gray level of the two sub-pixels equals to the target gray level. Although this method can to some degree relieve the color shift problem, and allows the viewer to view approximate colors when viewing the images from a side, it unfortunately decreases the resolution of the LCD.

The second conventional method is to increase a frequency for processing video data to two times of a frequency for transmitting the video data, that is, changing a frame rate of the LCD and displaying an image frame by stacking two sub-frames. This method eliminates the need of dividing pixels within the LCD panel so that the resolution of the LCD can not be decreased. However, it unfortunately causes image flicker when the LCD displays images.

### SUMMARY OF THE INVENTION

The present invention is directed to a driving method for an LCD. The driving method includes the steps of: transmitting video data to the LCD according to a first frequency, and processing the video data according to a first gamma look-up table to obtain a bright region image; transmitting the video data to the LCD according to the first frequency, and processing the video data according to a second gamma look-up table to obtain a dark region image; and stacking the bright region image and the dark region image in sequence so as to display an image to be displayed on an LCD panel of the LCD.

According to an embodiment of the present invention, a transmittance obtained by looking up the first gamma look-up table regarding a digital gray level value is greater than a transmittance obtained by looking up the second gamma look-up table regarding the same digital gray level value. A displaying time of the dark region image is longer than that of the bright region image.

According to an embodiment of the present invention, the step of generating the bright region image includes: looking up the first gamma look-up table for determining transmittances corresponding to all digital gray level values of the video data, and providing a corresponding first gray level voltage to pixels within the LCD panel accordingly.

According to an embodiment of the present invention, the step of generating the dark region image includes: looking up the second gamma look-up table for determining transmittances corresponding to all digital gray level values of the video data, and providing a corresponding second gray level voltage to the pixels within the LCD panel accordingly.

According to an embodiment of the present invention, a ratio of the displaying times of the dark region image and the bright region image is 2:1.

According to an embodiment of the present invention, the first frequency is a frame rate of the LCD, and the first frequency is 120 Hz.

The present invention is further directed to a driving method for an LCD. The driving method includes the steps of: transmitting video data to the LCD according to a first frequency, and processing the video data according to a first gamma look-up table to obtain a bright region image; transmitting the video data to the LCD according to the first frequency, and processing the video data according to a second gamma look-up table to obtain a first dark region image; transmitting the video data to the LCD according to a first frequency, and processing the video data according to a third gamma look-up table to obtain a second dark region image; and stacking the bright region image, the first dark region image and the dark region image in sequence so as to display an image to be displayed on an LCD panel of the LCD.

According to an embodiment of the present invention, a transmittance obtained by looking up the first gamma look-up table regarding a digital gray level value is greater than a transmittance obtained by looking up the second gamma look-up table regarding the same digital gray level value; the transmittance obtained by looking up the second gamma look-up table regarding the digital gray level value is greater than a transmittance obtained by looking up the third gamma look-up table regarding the same digital gray level value. A sum of displaying times of the first dark region image and the second dark region image is longer than a displaying time of the bright region image.

According to an embodiment of the present invention, the step of generating the bright region image includes: looking up the first gamma look-up table for determining transmittances corresponding to all digital gray level values of the video data, and providing a corresponding first gray level voltage to pixels within the LCD panel accordingly.

According to an embodiment of the present invention, the step of generating the first dark region image includes: looking up the second gamma look-up table for determining transmittances corresponding to all digital gray level values of the video data, and providing a corresponding second gray level voltage to the pixels within the LCD panel accordingly.

According to an embodiment of the present invention, the step of generating the second dark region image includes: looking up the third gamma look-up table for determining transmittances corresponding to all digital gray level values of the video data, and providing a corresponding third gray level voltage to the pixels within the LCD panel accordingly.

According to an embodiment of the present invention, a ratio of the displaying times of the first dark region image to the second dark region image to the bright region image is 1:1:1.

According to an embodiment of the present invention, the first frequency is a frame rate of the LCD, and the first frequency is 120 Hz.

The present invention further provides an LCD including a timing controller and an LCD panel. The timing controller is adapted for receiving video data transmitted by a first frequency, and respectively generating a bright region image and a first dark region image by processing the video data according to at least a first gamma look-up table and a second gamma look-up table which are built in the timing controller. The LCD panel is electrically connected to the timing controller, for stacking the bright region image and the first dark region image in sequence so as to display an image.

According to an embodiment of the present invention, a transmittance obtained by looking up a first gamma look-up table regarding a digital gray level value is greater than a transmittance obtained by looking up the second gamma look-up table regarding the same digital gray level value. A displaying time of the first dark region image is longer than a displaying time of the bright region image.

According to an embodiment of the present invention, the timing controller is adapted for looking up the first gamma look-up table for determining transmittances corresponding to all digital gray level values of the video data, and controlling a source driver to provide a corresponding first gray level voltage to the pixels within the LCD panel accordingly.

According to an embodiment of the present invention, the timing controller is adapted for looking up the second gamma look-up table for determining transmittances corresponding to all digital gray level values of the video data, and controlling a source driver to provide a corresponding second gray level voltage to the pixels within the LCD panel accordingly.

According to an embodiment of the present invention, a ratio of the displaying times of the first dark region image and the bright region image is 2:1.

According to an embodiment of the present invention, the first frequency is a frame rate of the LCD, and the first frequency is 120 Hz.

According to an another embodiment of the present invention, the timing controller is further adapted for generating a second dark region image by processing the video data according to a third gamma look-up table built in the timing controller.

According to an another embodiment of the present invention, the LCD panel is adapted for stacking the bright region image, the first dark region image, and the second dark region image so as to display the image.

According to an another embodiment of the present invention, a transmittance obtained by looking up the first gamma look-up table regarding a digital gray level value is greater than a transmittance obtained by looking up the second gamma look-up table regarding the same digital gray level value; the transmittance obtained by looking up the second gamma look-up table regarding the digital gray level value is greater than a transmittance obtained by looking up the third gamma look-up table regarding the same digital gray level value. A sum of displaying times of the first dark region image and the second dark region image is longer than a displaying time of the bright region image.

According to an another embodiment of the present invention, the timing controller is adapted for looking up the first gamma look-up table for determining transmittances corresponding to all digital gray level values of the video data, and controlling a source driver to provide a corresponding first gray level voltage to the pixels within the LCD panel accordingly.

According to an another embodiment of the present invention, the timing controller is adapted for looking up the second gamma look-up table for determining transmittances corresponding to all digital gray level values of the video data, and controlling a source driver to provide a corresponding second gray level voltage to the pixels within the LCD panel accordingly.

According to an another embodiment of the present invention, the timing controller is adapted for looking up the third gamma look-up table for determining transmittances corresponding to all digital gray level values of the video data, and controlling a source driver to provide a corresponding third gray level voltage to the pixels within the LCD panel accordingly.

According to an another embodiment of the present invention, a ratio of the displaying times of the first dark region image to the second dark region image to the bright region image is 1:1:1.

According to an another embodiment of the present invention, the first frequency is a frame rate of the LCD, and the first frequency is 120 Hz.

The present invention provides a driving method for an LCD. The driving method utilizes a same frequency for transmitting video data so that images displayed on the LCD thereof can not be happened flicker. In addition, the driving method eliminates the need of dividing the pixels within the LCD panel, so that the long felt problem of wide view angle color shift may be resolved without decreasing the resolution of the LCD.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system structure diagram of an LCD according to an embodiment of the present invention.

FIG. 2 is a schematic diagram illustrating a coupling correlation of a part of pixels within the LCD panel shown in FIG. 1.

FIG. 3 is a flow chart illustrating a driving method for an LCD according to an embodiment of the present invention.

FIG. 4 is a flow chart illustrating a driving method for an LCD according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention is provided to improve the disadvantages, i.e., decreasing of the resolution and image flicker, associated with the conventional solution for the problem of a wide view angle color shift.

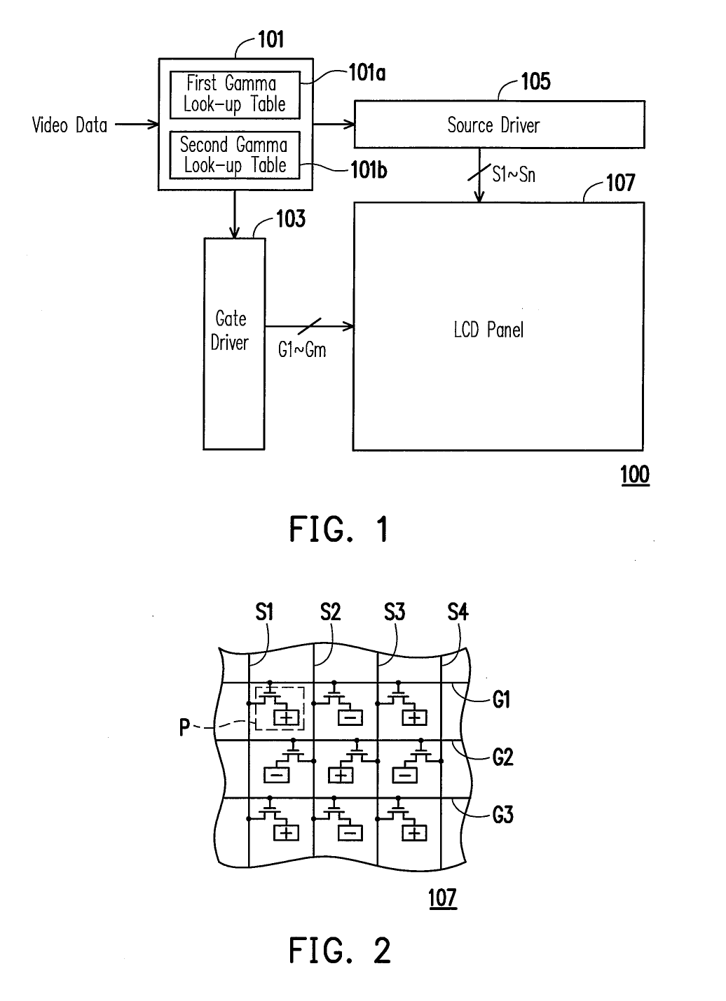

FIG. 1 is a system structure diagram of an LCD 100 according to an embodiment of the present invention. FIG. 2 is a schematic diagram illustrating a coupling correlation of a part of pixels within the LCD panel shown in FIG. 1. Referring to FIGS. 1 and 2 together, the LCD 100 includes a timing controller 101, a gate driver 103, a source driver 105 and an LCD panel 107. The gate driver 103 includes a plurality of gate lines G1 to Gm. The gate driver 103 is adapted to output scan signals in sequence via the gate lines G1 to Gm according to a basic timing signal provided by the timing controller 101, so as to correspondingly enable each row of pixels in the LCD panel 107.

The source driver 105 includes a plurality of source lines S1 to Sn. The source driver 105 is adapted to output data signals via the source lines S1 to Sn to the row of pixels, which is enabled by the gate driver 103, in the LCD panel 107 according to video data provided by the timing controller 101. As shown in FIG. 2, the LCD panel 107 includes a plurality of pixels P. Each of the pixels P is disposed at an intersection of a corresponding one of the gate lines G1 to Gm and a corresponding one of the source lines S1 to Sn. In more details, all pixels P of those odd number rows are disposed at intersections between those odd number gate lines G1, G3 . . . with corresponding source lines S1 to S3, and all pixels P of those even number rows are disposed at intersections between those even number gate lines G2, G4 . . . with corresponding source lines S2 to S4. However, the pixels are not restricted by the present invention as being disposed as shown in FIG. 2. The pixels can also be disposed in other ways.

The timing controller 101 is adapted for receiving video data transmitted by a first frequency, e.g., 120 Hz, and processing the received video data according to the first frequency and at least a first gamma look-up table 101a and a second gamma look-up table 101b, which are built in the timing controller 101, so as to obtain a bright region image and a first dark region image. According to an aspect of the embodiment, the timing controller 101 is adapted for looking up the first gamma look-up table 101a for transmittances corresponding to all digital gray level values of the received video data, and controlling the source driver 105 to provide a corresponding first gray level voltage to the pixels P, which are sequentially enabled by the gate driver 103, of the LCD panel 107 accordingly. In such a way, the source driver 105 drives all of the pixels P in the LCD panel 107, thus generating the bright region image.

Further, the timing controller 101 is adapted for looking up the second gamma look-up table 101b for transmittances corresponding to all digital gray level values of the received video data, and controlling the source driver 105 to provide a corresponding second gray level voltage to the pixels P, which are sequentially enabled by the gate driver 103, of the LCD panel 107 accordingly. In such a way, the source driver 105 drives all of the pixels P in the LCD panel 107, thus generating the first dark region image.

The LCD panel 107 is electrically connected to the timing controller 101, for stacking the bright region image and the first dark region image in sequence so as to display an image. According to an aspect of the embodiment, a transmittance obtained by looking up the first gamma look-up table 101a regarding a digital gray level value is greater than a transmittance obtained by looking up the second gamma look-up table 101b regarding the same digital gray level value. A displaying time of the first dark region image is longer than that of the bright region image. For example, a ratio between the displaying times of the first dark region image and the bright region image can be, but is not restricted to be, 2:1.

Therefore, the timing controller 101 utilizes a same frequency, i.e., 120 Hz, for transmitting the video data. And therefore, compared to the conventional method, which increases the frequency for processing the video data to two times of the frequency for transmitting the video data, the LCD 100 according to the embodiment of the present invention displays images without flickering. Further, the embodiment of the present invention need not require to divide the pixels P of the LCD panel 107, so that compared to the conventional method, which divides each of the pixels of the LCD panel 107 into two sub-pixels, the long felt problem of wide view angle color shift can be solved without decreasing the resolution of the LCD 100 according to the embodiment of the present invention. In other words, a gamma curve corresponding to a large view angle with respect to the LCD 100 according to the embodiment of the present invention is approximate to a gamma curve corresponding to a front view angle with respect to the LCD 100.

Furthermore, it can be learnt from the coupling correlation between the pixels P of the LCD panel 107, that when driven by a column inversion, the LCD panel 107 can obtain an effect as being driven by a dot inversion. In other words, while improving the displaying quality of the LCD 100, compared to those conventional driven by dot inversion, the LCD 100 according to the embodiment of the present invention consumes less power.

According to another embodiment of the present invention, besides the first gamma look-up table 101a, and the second gamma look-up table 101b built in the timing controller 101, the timing controller 101 further includes a third gamma look-up table (not shown) therein. For example, the timing controller 101 processes the received video data according to the first frequency, i.e., 120 Hz, and the first gamma look-up table 101a, and the second gamma look-up table 101b built in the timing controller 101, and generates the bright region image and the first dark region image. In addition, the timing controller 101 processes the received video data according to the first frequency and the third gamma look-up table built in the timing controller 101, and therefore generates a second dark region image.

In the current embodiment, the timing controller 101 is adapted for looking up the third gamma look-up table for transmittances corresponding to all digital gray level values of the received video data, and controlling the source driver 105 to provide a corresponding third gray level voltage to the pixels P, which are sequentially enabled by the gate driver 103, of the LCD panel 107 accordingly. In such a way, the source driver 105 drives all of the pixels P in the LCD panel 107, thus generating the second dark region image.

The LCD panel 107 thus stacks the bright region image, the first dark region image and the second dark region image in sequence so as to display the image. In the current embodiment, a transmittance obtained by looking up the first gamma look-up table 101a regarding a digital gray level value is greater than a transmittance obtained by looking up the second gamma look-up table 101b regarding the same digital gray level value; the transmittance obtained by looking up the second gamma look-up table 101b regarding the digital gray level value is greater than a transmittance obtained by looking up the third gamma look-up table regarding the same digital gray level value. A sum of displaying times of the first dark region image and the second dark region image is longer than a displaying time of the bright region image. For example, a ratio of the displaying times of the first dark region image to the second dark region image to the bright region image can be, but not restricted to be, 1:1:1.

Therefore, the timing controller 101 utilizes a same frequency, i.e., 120 Hz, for transmitting the video data. And therefore, compared to the conventional method, which increases the frequency for processing the video data to two times of the frequency for transmitting the video data, the LCD 100 according to the embodiment of the present invention displays images without flickering. Further, the embodiment of the present invention need not require to divide the pixels P of the LCD panel 107, so that compared to the conventional method, which divides each of the pixels of the LCD panel 107 into two sub-pixels, the long felt wide problem of view angle color shift can be even better resolved without decreasing the image resolution of the LCD 100 according to the embodiment of the present invention. In other words, a gamma curve corresponding to a large view angle with respect to the LCD 100 according to the embodiment of the present invention is more approximate to a gamma curve corresponding to a front view angle with respect to the LCD 100. Further, the LCD 100 according to the current embodiment of the present invention also consumes less power than those conventional LCDs.

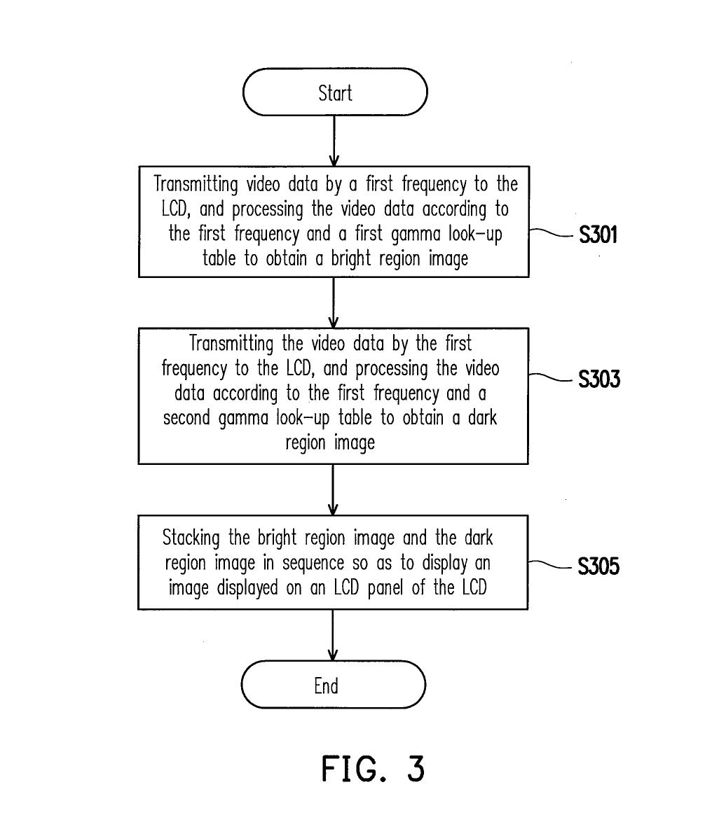

FIG. 3 is a flow chart illustrating a driving method for an LCD according to an embodiment of the present invention. Referring to FIG. 3, first at step S301, video data are transmitted by a first frequency, e.g., 120 Hz, to the LCD, and the video data are processed according to the first frequency and a first gamma look-up table for generating a bright region image. In step S301, the process of generating the bright region image includes: looking up the first gamma look-up table for transmittances corresponding to all digital gray level values of the video data, and providing a corresponding first gray level voltage to pixels of the LCD panel according to the transmittances. Then, at step S303, the video data are transmitted by the first frequency to the LCD, and the video data are processed according to the first frequency and a second gamma look-up table, so as to generate a dark region image. In step S303, the process of generating the dark region image includes: looking up the second gamma look-up table for transmittances corresponding to all digital gray level values of the video data, and providing a corresponding second gray level voltage to pixels of the LCD panel according to the transmittances. Finally at step S305, the bright region image and the dark region image are stacked in sequence, so as to display an image on the LCD panel of the LCD. In the current embodiment, a transmittance obtained by looking up the first gamma look-up table regarding a digital gray level value is greater than a transmittance obtained by looking up the second gamma look-up table regarding the same digital gray level value. A displaying time of the dark region image is longer than that of the bright region image. For example, a ratio between the displaying times of the dark region image and the bright region image can be, but is not restricted to be, 2:1.

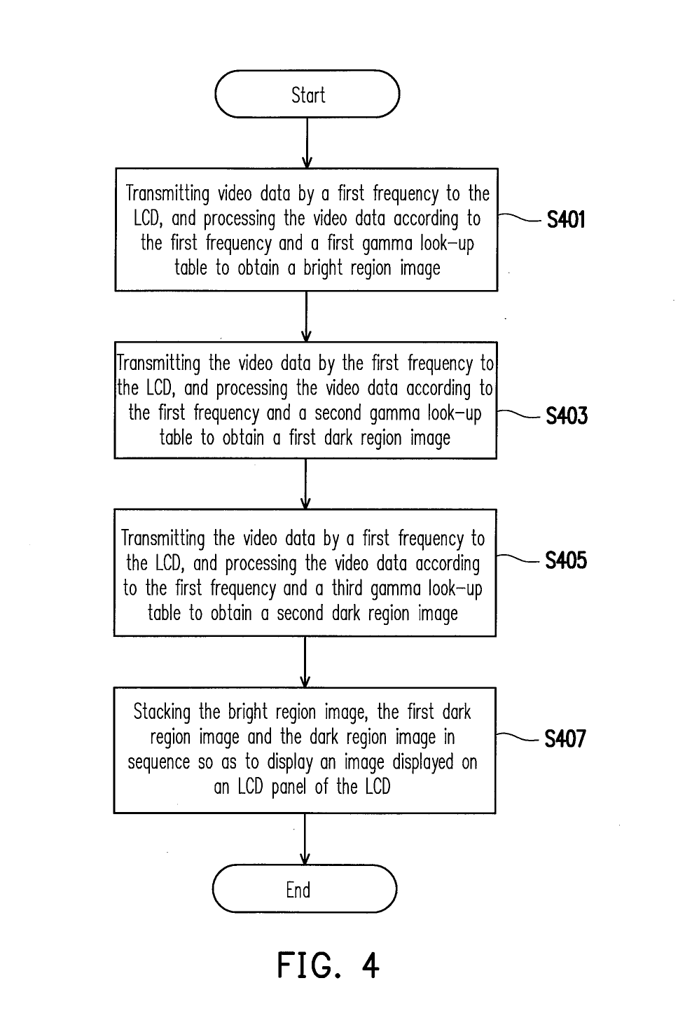

FIG. 4 is a flow chart illustrating a driving method for an LCD according to another embodiment of the present invention. Referring to FIG. 4, first at step S401, video data are transmitted by a first frequency, e.g., 120 Hz, to the LCD, and the video data are processed according to the first frequency and a first gamma look-up table for generating a bright region image. In the step S401, the process of generating the bright region image includes: looking up the first gamma look-up table for transmittances corresponding to all digital gray level values of the video data, and providing a corresponding first gray level voltage to pixels of the LCD panel according to the transmittances. Then, at step S403, the video data are transmitted by the first frequency to the LCD, and the video data are processed according to the first frequency and a second gamma look-up table, so as to generate a first dark region image. In step S403, the process of generating the first dark region image includes: looking up the second gamma look-up table for transmittances corresponding to all digital gray level values of the video data, and providing a corresponding second gray level voltage to pixels of the LCD panel according to the transmittances. Then, at step S405, the video data are transmitted by the first frequency to the LCD, and the video data are processed according to the first frequency and a third gamma look-up table, so as to generate a second dark region image. In step S405, the process of generating the second dark region image includes: looking up the third gamma look-up table for transmittances corresponding to all digital gray level values of the video data, and providing a corresponding third gray level voltage to pixels of the LCD panel according to the transmittances. Finally at step S407, the bright region image, the first dark region image and the second dark region image are stacked in sequence, so as to display an image on the LCD panel of the LCD. In the current embodiment, a transmittance obtained by looking up the first gamma look-up table regarding a digital gray level value is greater than a transmittance obtained by looking up the second gamma look-up table regarding the same digital gray level value; the transmittance obtained by looking up the second gamma look-up table regarding the digital gray level value is greater than a transmittance obtained by looking up the third gamma look-up table regarding the same digital gray level value. A sum of displaying times of the first dark region image and the second dark region image is longer than a displaying time of the bright region image. For example, a ratio of the displaying times of the first dark region image to the second dark region image to the bright region image can be, but is not restricted to be, 1:1:1.

It should be noted that although the first frequency is mostly exemplified by 120 Hz, those skilled in the art should be aware that the present invention is not subject to restrict the first frequency as exemplified. The first frequency, as practically needed, can be adaptively adjusted. Further, although there are at most three gamma look-up tables given as example for illustrating the present invention, the present invention does not restrict the quantity of gamma look-up tables used therein.

In summary, the driving method for driving an LCD according to the embodiment of the present invention utilizes a same frequency for transmitting video data so that images displayed on the LCD thereof can not be happened flicker. In addition, the driving method eliminates the need of dividing the pixels of the LCD panel, so that the long felt problem of wide view angle color shift may be resolved without decreasing the image resolution of the LCD.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving method for a liquid crystal display (LCD), comprising:
transmitting video data to the LCD according to a first frequency, and processing the video data according to a first gamma look-up table to obtain a bright region image;
transmitting the video data to the LCD according to the first frequency, and processing the video data according to a second gamma look-up table to obtain a dark region image; and
stacking the bright region image and the dark region image in sequence so as to display an image displayed on an LCD panel of the LCD,
wherein a transmittance obtained by looking up the first gamma look-up table regarding a digital gray level value is greater than a transmittance obtained by looking up the second gamma look-up table regarding the same digital gray level value, and a displaying time of the dark region image is longer than a displaying time of the bright region image.

2. The driving method according to claim 1, wherein the step of generating the bright region image comprises:
looking up the first gamma look-up table for determining transmittances corresponding to all digital gray level values of the video data, and providing a corresponding first gray level voltage to pixels within the LCD panel accordingly.

3. The driving method according to claim 1, wherein the step of generating the dark region image comprises:
looking up the second gamma look-up table for determining transmittances corresponding to all digital gray level values of the video data, and providing a corresponding second gray level voltage to pixels within the LCD panel accordingly.

4. The driving method according to claim 1, wherein a ratio of the displaying times of the dark region image and the bright region image is 2:1.

5. The driving method according to claim 4, wherein the first frequency is a frame rate of the LCD.

6. The driving method according to claim 1, wherein the first frequency is 120 Hz.

7. A driving method for a liquid crystal display (LCD), comprising:
transmitting video data to the LCD according to a first frequency, and processing the video data -according to a first gamma look-up table to obtain a bright region image;
transmitting the video data to the LCD according to the first frequency, and processing the video data according to a second gamma look-up table to obtain a first dark region image;
transmitting the video data to the LCD according to the first frequency, and processing the video data according to a third gamma look-up table to obtain a second dark region image; and
stacking the bright region image, the first dark region image, and the dark region image in sequence so as to display an image displayed on an LCD panel of the LCD,
wherein a transmittance obtained by looking up the first gamma look-up table regarding a digital gray level value is greater than a transmittance obtained by looking up the second gamma look-up table regarding the same digital gray level value; the transmittance obtained by looking up the second gamma look-up table regarding the digital gray level value is greater than a transmittance obtained by looking up the third gamma look-up table regarding the same digital gray level value; and a sum of displaying times of the first dark region image and the second dark region image is longer than a displaying time of the bright region image.

8. The driving method according to claim 7, wherein the step of generating the bright region image comprises:
looking up the first gamma look-up table for determining transmittances corresponding to all digital gray level values of the video data, and providing a corresponding first gray level voltage to pixels within the LCD panel accordingly.

9. The driving method according to claim 7, wherein the step of generating the first dark region image comprises:
looking up the second gamma look-up table for determining transmittances corresponding to all digital gray level values of the video data, and providing a corresponding second gray level voltage to the pixels within the LCD panel accordingly.

10. The driving method according to claim 7, wherein the step of generating the second dark region image comprises:
looking up the third gamma look-up table for determining transmittances corresponding to all digital gray level values of the video data, and providing a corresponding third gray level voltage to the pixels within the LCD panel accordingly.

11. The driving method according to claim 7, wherein a ratio of the displaying times of the first dark region image to the second dark region image to the bright region image is 1:1:1.

12. The driving method according to claim 7, wherein the first frequency is a frame rate of the LCD.

13. The driving method according to claim 12, wherein the first frequency is 120 Hz.

14. A liquid crystal display (LCD), comprising:
a timing controller, for receiving video data transmitted by a first frequency, and generating a bright region image and a first dark region image respectively by processing the video data according to at least a first gamma look-up table and a second gamma look-up table which are built in the timing controller; and
an LCD panel, electrically connected to the timing controller, for stacking the bright region image and the first dark region image in sequence so as to display an image,
wherein a transmittance obtained by looking up a first gamma look-up table regarding a digital gray level value is greater than a transmittance obtained by looking up the second gamma look-up table regarding the same digital gray level value, and a displaying time of the first dark region image is longer than a displaying time of the bright region image.

15. The LCD according to claim 14, wherein the timing controller is adapted for looking up the first gamma look-up table for determining transmittances corresponding to all digital gray level values of the video data, and controlling a source driver to provide a corresponding first gray level voltage to the pixels within the LCD panel accordingly.

16. The LCD according to claim 14, wherein the timing controller is adapted for looking up the second gamma look-up table for determining transmittances corresponding to all digital gray level values of the video data, and controlling a source driver to provide a corresponding second gray level voltage to the pixels within the LCD panel accordingly.

17. The LCD according to claim 14, wherein a ratio of the displaying times of the first dark region image and the bright region image is 2:1.

18. The LCD according to claim 14, wherein the first frequency is a frame rate of the LCD.

19. The LCD according to claim 18, wherein the first frequency is 120 Hz.

20. The LCD according to claim 14, wherein the timing controller is adapted for generating a second dark region image by processing the video data according to a third gamma look-up table built in the timing controller.

21. The LCD according to claim 20, wherein the LCD panel is adapted for stacking the bright region image, the first dark region image, and the second dark region image so as to display an image,
wherein a transmittance obtained by looking up the first gamma look-up table regarding a digital gray level value is greater than a transmittance obtained by looking up the second gamma look-up table regarding the same digital gray level value; the transmittance obtained by looking up the second gamma look-up table regarding the digital gray level value is greater than a transmittance obtained by looking up the third gamma look-up table regarding the same digital gray level value; and a sum of displaying times of the first dark region image and the second dark region image is longer than a displaying time of the bright region image.

22. The LCD according to claim 21, wherein the timing controller is adapted for looking up the first gamma look-up table for determining transmittances corresponding to all digital gray level values of the video data, and controlling a source driver to provide a corresponding first gray level voltage to the pixels within the LCD panel accordingly.

23. The LCD according to claim 21, wherein the timing controller is adapted for looking up the second gamma look-up table for determining transmittances corresponding to all digital gray level values of the video data, and controlling a source driver to provide a corresponding second gray level voltage to the pixels within the LCD panel accordingly.

24. The LCD according to claim 21, wherein the timing controller is adapted for looking up the third gamma look-up table for determining transmittances corresponding to all digital gray level values of the video data, and controlling a source driver to provide a corresponding third gray level voltage to the pixels within the LCD panel accordingly.

25. The LCD according to claim 21, wherein a ratio of the displaying times of the first dark region image to the second dark region image to the bright region image is 1:1:1.
